(19) United States
(12) Patent Application Publication
(10) Pub. No.: US 2019/0147397 A1
(43) Pub. Date: May 16, 2019

(54) SYSTEMS AND METHODS FOR MANAGING AND VALIDATING THE EXCHANGE OF PRODUCT INFORMATION

(71) Applicant: GeoPRI, LLC, Arlington, MA (US)

(72) Inventor: Matthew Hodges, Arlington, MA (US)

(21) Appl. No.: 16/300,152

(22) PCT Filed: May 5, 2017
(86) PCT No.: PCT/US17/31243

§ 371 Date: Nov. 9, 2018

Related U.S. Application Data
(60) Provisional application No. 62/334,096, filed on May 10, 2016.

(51) Int. Cl. G06Q 10/08; G06F 16/27

(52) U.S. Cl. CPC G06Q 10/0833; G06F 16/27

(57) ABSTRACT

The invention provides systems and methods for monitoring the movement of a product in a supply chain and further managing the exchange of traceability information of the product as it moves among members or entities in the supply chain.

### CROSS-REFERENCE TO RELATED APPLICATIONS

This application claims the benefit of, and priority to, U.S. Provisional Patent Application No. 62/334,096, filed May 10, 2016, the content of which is incorporated by reference herein in its entirety.

### FIELD OF THE INVENTION

The invention generally relates to systems and methods for managing the exchange of traceability information of a product moving among members or entities in a supply chain.

### BACKGROUND

Traceability may generally be understood to be the ability to keep track of and further verify the history, location, application, or other information, of one or more items along a distribution or supply chain. Traceability has become a vital aspect of business in many industries. For example, traceability is a critical aspect for companies that want to provide consumers with product transparency. In particular, a consumer may be interested in knowing specific information about a product they either purchased or are interested in purchasing. In the instance of food, a consumer may want to know the origin of the food product, as well as who produced it, and how it was produced. Additionally, traceability has important aspects for product safety, such as in the food and other industries. For example, the globalization of the food industry and the relative ease with which food commodities are transported through and between countries and continents requires precise monitoring of the movement of a food product within a supply chain. One of the key reasons this is such a critical point is in instances where an issue of contamination arises, and a recall is required. Where traceability has been closely adhered to, it is possible to identify which food products must be recalled by tracing of the contaminated product back through the supply chain so as to determine the origin of the contamination, as well as identity which food products are safe, potentially saving millions of dollars in the recall process.

Many current tracking systems utilize barcoded labels as a means of identifying and distinguishing goods through the supply chain. In most instances, items are barcoded with a single barcode label and then followed through the supply chain based on tracking of the barcode. More specifically, the movement of an item (e.g., good, product, lot of goods or products, etc.) is generally tracked based on single barcode scanning events occurring along the supply chain (e.g., the barcode label is scanned upon leaving a warehouse, the barcode label is scanned upon delivery to a store, etc.).

A problem with current tracking systems and methods is that they lack an ability to provide adequate communication between independent tracking systems managed by different members of a supply chain. In particular, an item may exchange hands multiple times as it moves along a supply chain and may thus undergo numerous supply chain activities that are tracked via barcode scanning events. However, some of the exchanges may occur between two different members of the supply chain that are otherwise unassociated with one another. For example, in some instances, an item may be transferred from a manufacturer (associated with company A) to a distributor (associated with company B), such that, but for the actual exchange of the item, the manufacturer and distributor have no further connection. Both members may manage their own respective tracking systems independent of one another, such that data associated with barcode scanning events occurring when the item is in the custody of a member may be separately stored and managed in repositories of the respective independently operated tracking system of that member. As an item continues to move along the supply change, additional exchanges between different members may occur. Thus, the overall volume of traceability data continues to grow, while portions or subsets of overall traceability set are separately stored and managed in the independently operated tracking systems of respective members.

The currently employed tracking systems and methods, however, are unable to provide an effective means of communicating the portions or subsets of traceability data across multiple independent tracking systems managed by different members of a supply chain. In particular, under current tracking schemes, a full set of traceability data (e.g., data including all barcode scanning events from a point of origin to a point of destination, including any item exchanges among members) is not available to any given member at a single instance. For example, current systems lack the ability to support queries spanning multiple independent repositories of the independently operated tracking systems, which would otherwise be required in order to build the full set of traceability data from the portions or subsets of data. Accordingly, current tracking systems and methods may fail to provide information that may be critical to a given situation, such as in instances in which a complete set of traceability data is crucial for verifying the authenticity of a food product, for verifying the handling and movement of a product for use in product safety (e.g., food recalls).

### SUMMARY

The invention recognizes a need to be able to provide improved and more comprehensive communication between independent tracking systems managed by different members of a supply chain than current tracking systems and methods provide.

Aspects of the present invention provide a system including a distributed network, in which members or entities in a supply chain are provided with complete control over independent and privately-managed data repositories, or databases, across the distributed network. Each privately-managed data repository may include a self-sufficient and complete set of traceability data, the dissemination of which may be managed by the associated member. During the course of supply chain activity, a product may transfer from one member of the supply chain to another member. Such a transfer may include a transfer in ownership or a transfer of custody over the product. In the event that the transferring member and receiving member are associated with different privately-managed data repositories, the transfer of product may result in the automated transfer of the product's traceability data from the transferring member's privately-managed data repository to the receiving member's privately-managed data repository. In particular, a copy of the product traceability data is generated and transferred from the transferring member's privately-managed data repository to the receiving member's privately-managed data repository. By receiving the copy of product traceability data, the receiving member's privately-managed data repository is provided with a full set of traceable history of the product without the need for the receiving member to have to query the transferring member's privately-managed data repository, or any other privately-managed data repository in the distributed network.

Accordingly, the present invention provides improved data sharing among privately-managed data repositories across a distributed network. Product traceability data may generally include a history of all transfers of the product between entities, and thus further includes a corresponding history of all repository or database transfers (i.e., transfer of traceability data between privately-managed data repositories in the distributed network). Thus, by generating and transferring a copy of product traceability data from a transferring privately-managed data repository to a receiving privately-managed data repository each time a product is transferred among entities, the receiving privately-managed repository is able to generate a complete traceability history of the product without the need to issue requests to other privately-managed data repositories across the network in the event a member initiates a query. Therefore, the present invention allows for independent data repositories in a distributed network to have complete query and data analysis without triggering a complex cascade of queries, which could result in lag time and further complicate data exchange processes.

Aspects of the invention are accomplished by providing a system associated with a first entity and configured to manage product traceability data of a product that is moving within a supply chain. The system includes a first database including product traceability data associated with the product, wherein the product traceability data includes a unique identifier that is associated with the product. The system is configured to communicate with a second system associated with a second entity, wherein the second system includes a second database associated therewith. Upon receiving an input that the product is being transferred to the second entity, the system is configured to generate a copy of the product traceability data and transfer the copy to the second database of the second system in order to provide the second entity with a traceable history of the product without the second database having to query the first database.

In some embodiments, the input that the product is being transferred includes assignment data associated with an assignment of the product from the first entity to the second entity. The assignment data may include, but is not limited to, identity of the first and the second entities, type of assignment, consideration exchanged as part of the assignment, date and time of the assignment, and a combination thereof. The type of assignment may include a transfer of ownership of the product or a transfer of custody of the product, for example.

In some embodiments, the unique identifier is associated with a tag associated with the product. The tag may include a digital representation of a machine-readable label or indicia. For example, the machine-readable label of indicia may include, for example, text, graphics, an image, a linear barcode, a matrix barcode, an RFID element, and a combination thereof. In some embodiments, the product may include a product lot including one or more product units. Thus, each of the one or more product units may have a tag associated therewith, wherein the product traceability data includes a unique identifier associated with each tag.

In some embodiments, the product traceability data includes product information including, but not limited to, an identity of the product, characteristics of the product, location of the product, characteristics of the location, traceability information of the product, transactional data related to one or more exchanges of the product, and a combination thereof. The characteristics of the product may include, for example, physical attributes of the product, origin of the product, destination of the product, and a combination thereof. The characteristics of the location of the product may include, for example, an operator of the location, overall capacity of the location, current capacity of the location, seasonality of the location, operational status of the location, current weather at the location, and a combination thereof.

The traceability information may generally include supply chain activities or events associated with the product. The supply chain activities or events may include, for example, processing of the product, storage of the product, movement of product from one location to another location, sampling of the product, evaluation of the product, and a combination thereof.

The transactional data may include, for example, an identity of one or more entities associated with the exchange of the product, a quantity of the product exchanged, a price paid for the product, a date of the exchange of the product, and a combination thereof.

Further aspects of the invention are able to provide comprehensive data segregation and security measures to allow for controlled dissemination of a product's traceability information and further allow for maintaining the integrity of a product's traceability information as the product moves through various stages of the supply chain and possibly exchanges hands multiple times. For example, the present invention further includes data validation systems and processes to validate transfers of traceability data among repositories or databases in the distributed network. In particular, the data validation systems and processes are configured to ensure that such transfers are valid (e.g., verifying identity of receiving entity and associated receiving database and further verifying authorization of receiving entity for access to data to be transferred) and further validating the integrity of the data to be transferred (e.g., ensure that data is not compromised).

For example, some aspects of the present invention provide a system including a distributed network, in which members or entities in a supply chain are provided with complete control over independent and privately-managed data repositories across the distributed network. Each privately-managed data repository may include a self-sufficient and complete set of traceability data, the dissemination of which may be managed by the associated member. The invention allows each member to control the dissemination of exchange of information from their respective repository. For example, in the distributed network, there may be many communicating repositories, each sharing a portion of traceability data (e.g., public data) according to permissions granted by their associated members, but each may further limit access to privileged traceability data (e.g., private data) according to local access control policies or permissions, which may further include data security measures, such as data validation. Therefore, by providing controlled dissemination of a product's traceability data and further providing data validation measures to maintain the integrity of a product's traceability data during data exchanges, the present invention reduces the risk of data breaches and potential for data manipulation, thereby reducing the likelihood of fraudulent activities to take place, such as food fraud or adulteration.

### BRIEF DESCRIPTION OF THE DRAWINGS

FIG. 1 is a block diagram illustrating one embodiment of an exemplary system for managing the exchange of product traceability information.

FIG. 2 is a block diagram illustrating a distributed network including a plurality of remote servers configured for peer-to-peer communication, each remote server including an integrated supply chain system.

FIG. 3 is a block diagram illustrating an exemplary integrated supply chain system.

FIG. 4 is a block diagram illustrating the distributed database management module of FIG. 3 in greater detail.

FIGS. 5A and 5B illustrate a continuous flowchart of an exemplary supply chain for coffee.

FIG. 6 is a flow diagram illustrating one embodiment of a method for managing product traceability data of a product that is moving among entities in a supply chain.

FIG. 7 is a block diagram illustrating an exemplary system for managing the exchange of a product's traceability data between privately-managed databases across a distributed network based on the transfer of the product between entities associated with the privately-managed databases.

FIG. 8 is a block diagram illustrating the data security/authentication module of the system of FIG. 7 in greater detail.

FIG. 9 is a block diagram illustrating the validation of a product traceability data transfer based on the data validation processes of the system of FIG. 7.

FIG. 10 shows an exemplary visual representation of product information outputted to a user device.

### DETAILED DESCRIPTION

The invention generally relates to systems and methods for providing traceability and supply chain management of a product, good, resource, or the like. In particular, the invention provides systems and methods for managing the exchange of traceability information of a product moving among members or entities in a supply chain.

For purposes of discussion, and ease of explanation, the exemplary systems and methods described herein refer to tracking and tracing of a food product, specifically coffee. However, it should be noted that systems and methods of the present invention apply to all types of products, goods, services, resources, and the like, and are not limited solely to food-related product. For example, systems and methods of the present invention may apply to all types of commodities, including agricultural commodity goods, including grains (e.g., corn, oats, wheat, rice, etc.), food goods (e.g., cocoa, salt, sugar, coffee, tea, spices, produce, fruits, vegetables, nuts, seeds (e.g., sesame), legumes, etc.), livestock and meat (e.g., chicken, cattle, hogs, etc.), energy commodity goods (e.g., crude oil, ethanol, natural gas, heating oil, propane, electricity, etc.), hard commodity goods, such as metals (e.g., industrial metals such as copper, lead, tin, aluminum, steel, etc., as well as precious metals such as gold, platinum, silver, etc.), as well as minerals or other mined goods (e.g., coal, precious gemstones, etc.). The systems and methods of the present invention may also apply to other types of goods and products, including, but not limited to, durable goods, such as lumber, furniture, appliances, electronics, toys, as well as nondurable or soft goods, such as textiles, clothing, cleaning products, pharmaceutical products such as medications, and the like.

The present invention discloses various systems and methods for providing comprehensive communication between independent tracking systems managed by different members of a supply chain The systems and methods of the present invention further provide comprehensive data segregation and security measures to allow for controlled dissemination of a product's traceability data and further allow for maintaining the integrity of a product's traceability data as a product moves through various stages of the supply chain and possibly exchanges hands multiple times. As generally understood, a supply chain consists of parties involved, either directly or indirectly, in the sequence of activities and/or processes required to bring a product or service from its raw state to the finished state provided to the consumer or requesting customer. The supply chain can include the manufacturer and suppliers, and also transporters, warehouses, retailers, and customers/consumers.

The systems and methods of the present invention generally include an integrated supply chain system configured to provide a platform or interface with which one or more users, specifically members of a supply chain, may interact so as to either manage supply chain activities/processes (e.g., manufacturing and processing, processing of orders, shipments, and the like) or simply access supply chain information associated with a product, such as traceability information or specific product content associated with a product. The integrated supply chain system may generally be embodied as an internet-based computing system in a distributed network, in which there are a plurality of remote servers networked to allow for data collection and compilation and online access to such data. In one embodiment, the system may be embodied on a cloud-based service, and provide an interface such that users, including, but not limited to, producers, exporters, importers, retailers, and consumers, may access the system and interact with the interface so as to have access to supply chain information and/or management of a product, particularly as a product moves through a supply chain.

In the embodiments described herein, the overall system includes a plurality of remote servers in a distributed network, each remote server being associated with a member or entity of the supply chain. Each of the remote servers may be configured to communicate directly with one another (e.g., via peer-to-peer communication) and each may include their own integrated supply chain system. Accordingly, members or entities in a supply chain may be provided with complete control over independent and privately-managed data repositories or databases for each remote server across the distributed network. Each privately-managed data repository may include a self-sufficient and complete set of traceability data, the dissemination of which may be managed by the associated member or entity.

The systems and methods of the present invention allow for each member to control the dissemination or exchange of information from their respective repository. For example, in the distributed network, there may be many communicating repositories, each sharing a portion of traceability data (e.g., public data) according to permissions granted by their associated members, but each may further limit access to privileged traceability data (e.g., private data) according to local access control policies or permissions, which may further include data security measures, such as data validation. Therefore, by providing controlled dissemination of a product's traceability data and further providing data validation measures to maintain the integrity of a product's traceability data during data exchanges, the present invention reduces the risk of data breaches and potential for data manipulation, thereby reducing the likelihood of fraudulent activities to take place, such as food fraud or adulteration.

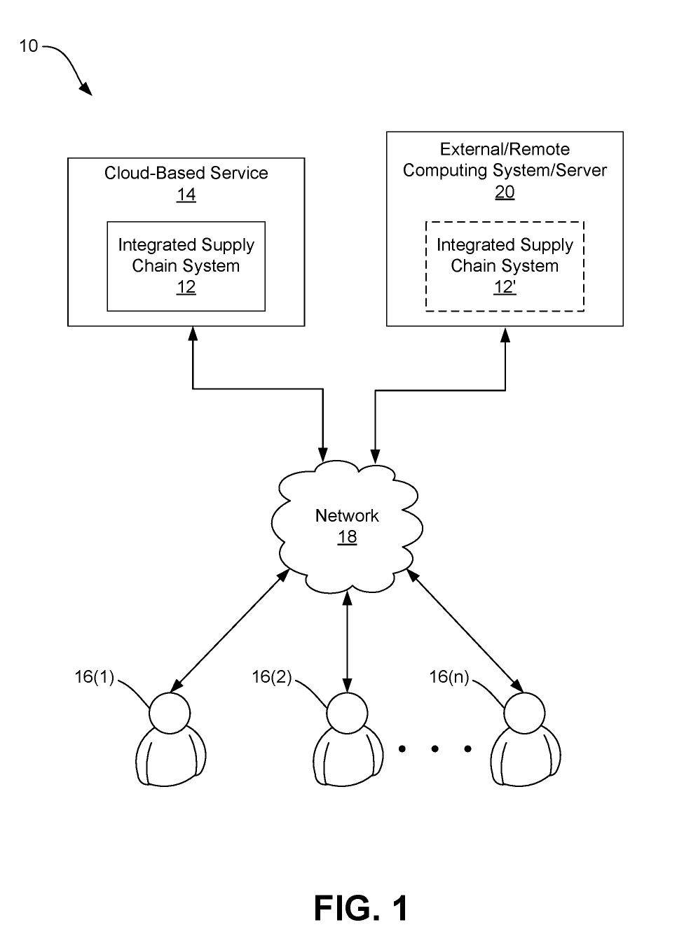

FIG. 1 is a block diagram illustrating one embodiment of an exemplary system 10 for providing traceability and supply chain management of a product and for managing the exchange of traceability information of a product moving among members or entities in a supply chain. As shown, the system 10 includes an integrated supply chain management system 12 embodied on an internet-based computing system/service. For example, as shown, the integrated supply chain management system 12 may be embodied on a cloud-based service 14, for example. The integrated supply chain management system 12 is configured to communicate and share data with one or more users 16(1)-16(n) over a network 18. In the present context, the users 16(1)-16(n) may include one or more members of a supply chain associated with a particular product, for example, a manufacturer, producer, or distributor of the cargo. Additionally, or alternatively, some members of a supply chain 16(1)-16(n) may include a consumer or customer to which the product is to be sold/provided (e.g., single consumer, retailer, store owner, destination owner, etc.). In some embodiments, a user 16 may further include one or more members of a commodity exchange, particularly when the product is a commodity good, such as coffee. Additionally, or alternatively, the users 16(1)-16(n) may include a particular entity (e.g., country, nation, sovereign state, jurisdiction, enterprise, etc.) of a supply chain associated with the particular product. Accordingly, the terms “member” and “entity” may be used interchangeably throughout the present disclosure.

The system 10 further includes an external/remote computing system/server 20 configured to communicate with at least the cloud-based service 14, and subsequently the integrated supply chain management system 12, via the network 18. The external/remote computing system/server 20 may be embodied as a remote server, for example, for communicating with the integrated supply chain management system 12 and for performing other functions described herein.

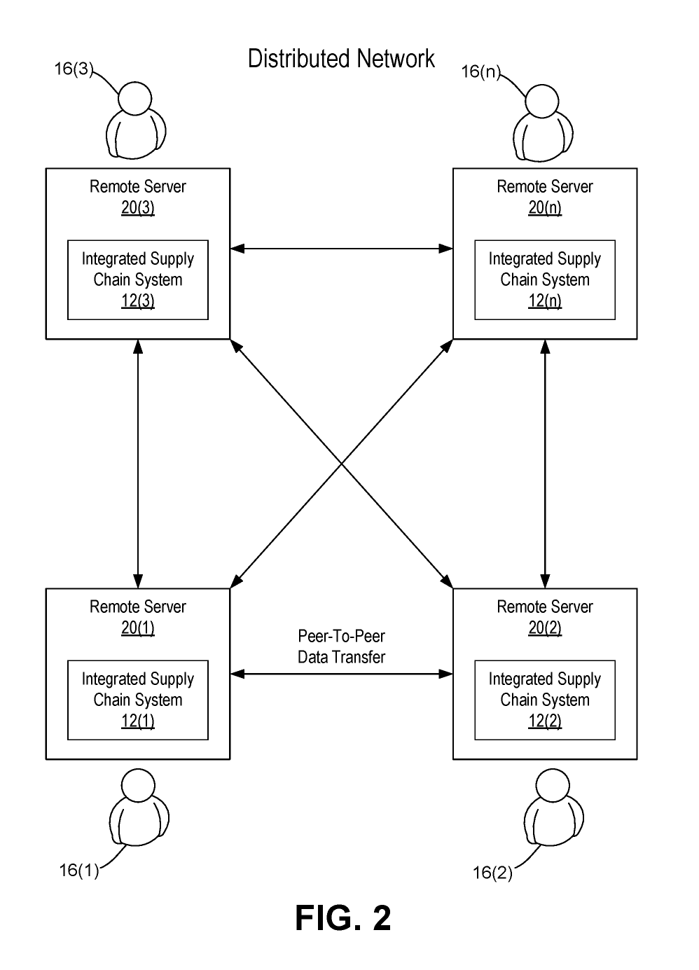

As described in greater detail herein, system 10 may be embodied as a distributed network (shown in FIG. 2,) in which there are a plurality of remote servers 20, each of which may be associated with a member or entity of the supply chain. Accordingly, in some embodiments, each remote server 20 may include an integrated supply chain management system, similarly configured as the integrated supply chain management system 12 described herein, so as to provide each member or entity of the supply chain with a degree of control over traceability, supply chain management, and traceability data dissemination functions.

The network 18 may be any network that carries data. Non-limiting examples of suitable networks that may be used as network 18 include Wi-Fi wireless data communication technology, the internet, private networks, virtual private networks (VPN), public switch telephone networks (PSTN), integrated services digital networks (ISDN), digital subscriber link networks (DSL), various second generation (2G), third generation (3G), fourth generation (4G) cellular-based data communication technologies, Bluetooth radio, Near Field Communication (NFC), the most recently published versions of IEEE 802.11 transmission protocol standards, other networks capable of carrying data, and combinations thereof. In some embodiments, network 18 is chosen from the internet, at least one wireless network, at least one cellular telephone network, and combinations thereof. As such, the network 18 may include any number of additional devices, such as additional computers, routers, and switches, to facilitate communications. In some embodiments, the network 18 may be or include a single network, and in other embodiments the network 16 may be or include a collection of networks.

As described in greater detail herein, the integrated supply chain management system 12 is configured to provide an interface with which the one or more users 16(1)-16(n) may interact for the purposes of either supply chain management or providing traceability information of a product, or other types of information generally related to the product or supply chain activities or events associated with the product, as will be described in greater detail herein.

For example, the integrated supply chain management system 12 is configured to communicate and share data with a device associated with one or more users 16 (hereinafter referred to as user device). The user device may be embodied as any type of device for communicating with the integrated supply chain management system 12 and cloud-based service 14, and/or other user devices over the network 18. For example, at least one of the user devices may be embodied as, without limitation, a computer, a desktop computer, a personal computer (PC), a tablet computer, a laptop computer, a notebook computer, a mobile computing device, a smart phone, a cellular telephone, a handset, a messaging device, a work station, a distributed computing system, a multiprocessor system, a processor-based system, and/or any other computing device configured to store and access data, and/or to execute software and related applications consistent with the present disclosure.

The integrated supply chain management system 12 is configured to receive and analyze data provided thereto from one or more users related to a product. The data is generally related to supply chain activities/processes of the product, including production and handling of the product, exchanges or transactions involving the product, and transportation and movement of the product through the supply chain. Accordingly, users may have access to product data in real-time or near real-time as the product moves in the supply chain. In addition to providing information related to a product, the integrated supply chain management system 12 is configured to provide data validation systems and processes to validate transfers of traceability data among remote servers 20 in the distributed network. In particular, the data validation systems and processes are configured to ensure that such transfers are valid (e.g., verifying identity of receiving entity and associated receiving database and further verifying authorization of receiving entity for access to data to be transferred) and further validating the integrity of the data to be transferred (e.g., ensure that data is not compromised), as will be described in greater detail herein.

In some embodiments, the interface provided by the integrated supply chain system 12 may present information related to the product as well as supply chain management to a user 16 via a display operatively coupled to the user device. The product information may include, but is not limited to, traceability information, general information about the product itself, information about specific activities or processes of the supply chain through which the product has gone through or is scheduled to go through, information about members or entities of the supply chain that may be involved with the product, and the like. The interface may further allow the user to interact with the supply chain management and product information (e.g., filter, sort, access different sets of data, etc.) and further communicate with the integrated supply chain management system 12 (e.g., provide input data). Accordingly, the user 16 is able to have continual visibility to product information, such as traceability information of a product (such as information related to current location, any previous location, and next destination, etc.), as well as supply chain management data and tools (e.g., assignment of specific data to a product, assignment of an identifier label to a product, updating of product data, etc.).

As will be described in greater detail herein, the integrated supply chain management system 12 of the present invention is configured to allow multiple users to contribute to and draw from a shared flow of data, from the point of origin of the product all the way to sale or delivery to the consumer or customer. More specifically, the system 12 is configured to allow members or entities along a supply chain to exchange information with one another along the entire supply chain, thereby integrating traceability data from all members and allowing such data to be visible. The system 12 is configured to establish connections between users that may be associated with one another, or otherwise share a common interest (e.g., each user plays a role in supply chain of a given product), and thus allow access to traceability data based on the established connections.

The system 12 of the present invention contrasts with current supply chain systems which generally utilize an “over-the-fence” model. More specifically, current supply chain systems may consist of many independent closed software systems configured to simply pass data along from one member to the next, with little or no flexibility in how the information is collected or shared. Unlike the integrated supply chain management system 12, current systems generally pass data along in a chain-like fashion, from one link in the chain to the next.

As previously described, the integrated supply chain system 12 may generally be embodied as an internet-based computing system, such as a cloud-based computing service. Accordingly, the system 10 may generally include a group of remote servers across a distributed network, each remote server configured to communicate with one another (via peer-to-peer communication) to allow sharing of data related to a product in a supply chain and further allow online access to such data, including traceability information of the product as it moves along the supply chain, as well as management of the supply chain.

For example, as shown in FIG. 2, the system 10 may be embodied as a distributed network including a plurality of remote servers 20(1)-20(n), each of which may be tied to, or otherwise associated with, a separate user 16(1)-16(n), such as particular member or entity of the supply chain. As previously described, the member or entity may include, but are not limited to, a manufacturer, producer, or distributor of product cargo, a consumer or customer to which the product is to be sold/provided (e.g., single consumer, retailer, store owner, destination owner, etc.), one or more members of a commodity exchange, particularly when the product is a commodity good, such as coffee, or an individual country, nation, sovereign state, jurisdiction, enterprise, or the like.

Each remote server 20 may provide an associated user 16 with complete control over one or more independent and privately-managed data repositories or databases. Each privately-managed data repository or database may include a self-sufficient and complete set of traceability data, for example. The remote server 20 may provide a user 16 with control or management over the dissemination of such traceability data. For example, each remote server 20(1)-20(n) may include a separate integrated supply chain management system 12(1)-12(n), similarly configured as the integrated supply chain management system 12 described herein, so as to provide the associated user 16(1)-16(n) with a degree of control over traceability, supply chain management, and traceability data dissemination functions. Each of the systems 12(1)-12(n) may be configured to partition certain data into data repositories or databases of each remote server 20(1)-20(n) based, at least in part, on defined protocols. For example, some data that may pass through system 12 may be privileged and may be tied to specific users 16, and thus may be rerouted to a privately-managed data repository or database associated with a remote server 20 to which the user 16 is tied.

As will be described in greater detail herein, users 16 are able to control the dissemination or exchange of information from their respective data repository or database via the system 12 of their associated remote server 20. For example, in the distributed network shown in FIG. 2, the remote servers 20(1)-20(n) are configured to directly communicate with one another via peer-to-peer communication protocols. Thus, data transfer between remote servers 20 may be facilitated through the associated systems 12. The system 10 further provides security measures to allow for the controlled dissemination of traceability data and further allow for maintaining the integrity of traceability data as a product moves through various stages of the supply chain and possibly exchanges hands multiple times.

The integrated supply chain system 12 may be provided to the users 16 via one or more service models associated with the cloud-based service.

In one embodiment, access to the system 12 may be provided via software as a service (SaaS) model. In a SaaS model, a cloud service provider (e.g., third-party provider of system 12) may install and operate the software associated with the integrated supply chain management system 12 in the cloud and users may access the software via their user devices. More specifically, the software is centrally hosted via the cloud and may be accessed and run on the user devices, thereby providing access to the system 12 and the interface with which the user may interact for the purposes of either supply chain management or providing traceability information of a product. The SaaS model eliminates the need to install and run an application directly on a user's own device, simplifying maintenance and support. Furthermore, the users 16 are not responsible for managing the cloud infrastructure and platform where the application runs. Instead, a third-party provider is able to maintain and manage the infrastructure and platforms that run the system hardware and software application.

Other types of cloud-based service models may include, for example, a platform as a service (PaaS) model and an infrastructure as a service (IaaS) model. In the PaaS model, the third-party provider hosts hardware and software on its own infrastructure while providing hardware and software tools to its users as a service. Accordingly, the third-party provider is able to deliver a computing platform to the user device, wherein the platform may include, but is not limited to, an operating system, programming language execution environment, database, and web server, all while hosting the hardware and software on its end. In the IaaS model, a third-party provider may generally provide virtualized computing resources over one or more networks. For example, a third-party provider may host the hardware, software, servers, storage and other infrastructure components on behalf of its users. The third-party provided may also host users' applications and handle tasks including system maintenance, backup and resiliency planning.

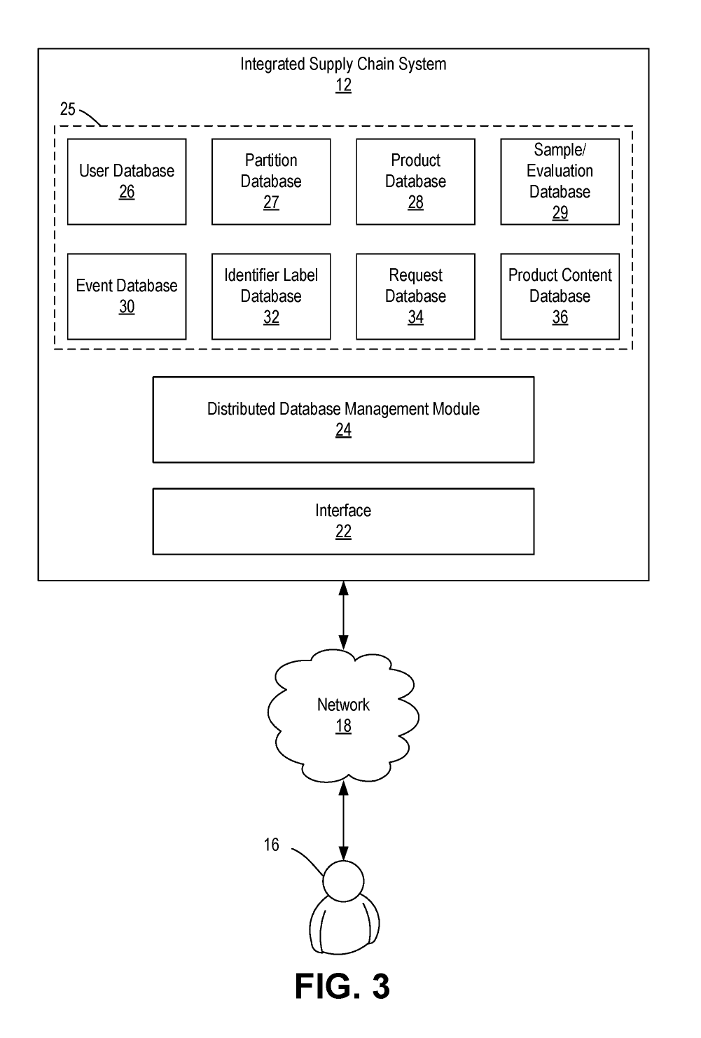

FIG. 3 is a block diagram illustrating an exemplary integrated supply chain system 12. As shown, the integrated supply chain system 12 may include an interface 22, a distributed database management module 24, and various databases 25 for storing data related one or more users, one or more products in the supply chain, supply chain events, activities and processes associated with the product, specific requests associated with the product or supply chain events, activities and processes, and identifier labels associated, or to be associated with, one or more products. For example, the distributed database management module 24 may be configured to communicate and exchange data with a user database 26, a partition database 27, a product database 28, a sample/evaluation database 29, an event database 30, an identifier label database 32, a request database 34, and a product content database 36, each of which is described in greater detail herein.

As previously described, the interface 22 may generally allow a user 16 to access and share data with one or more components of the system 12. For example, upon accessing the system 12 on the cloud-based service 14, the interface 22 may be presented to the user on a user device, in which the user may navigate a dashboard or standard platform interface so as to access either traceability data related to a specific product or to access tools for supply chain management. For example, a consumer may be interested in knowing specific information about a product they either purchased or are interested in purchasing. In the instance of food, a consumer may want to know the origin of the food product, as well as who produced it, and how it was produced. Accordingly, a consumer may access the system 12 via a consumer device (e.g. computing device such as a smartphone, tablet, PC) so as to remotely view traceability information related to the product. In another example, a producer of a product may be interested in providing data related to a product they are about to process. Accordingly, the producer may access the system 12 via a user device so as to access supply management tools for allowing the input of such data to be associated with the product to be processed.

The exchange and handling of data between the integrated supply chain system 12 and the users 16, as well as the various databases (26-36) is generally managed by the distributed database management module 24. The distributed database management module 24 may generally operate according to a distributed data model, in which storage devices (e.g., databases 26-36) are not all attached to a common processing unit. For example, one or more of the databases 26-36 may be stored different computers or servers, located in the same physical location or may be dispersed over a network of interconnected computers. For example, some of the databases 26-36 may be distributed across multiple physical locations, such that they can reside on network servers on the Internet, on corporate intranets or extranets, or on other networks. Accordingly, by storing data across multiple computers, distributed databases can improve performance at end-user worksites by allowing transactions to be processed on many machines, instead of being limited to one.

With reference to FIG. 2, the remote servers 20(1)-20(n), each of which are associated with a particular user 16, may include privately-managed repositories or databases which may include specific information that may be privileged and thus access to such information may be controlled by the particular user 16. Thus, while some information may be generally available to most users, some information is restricted, and access to such information is governed according to local access control policies or permissions.

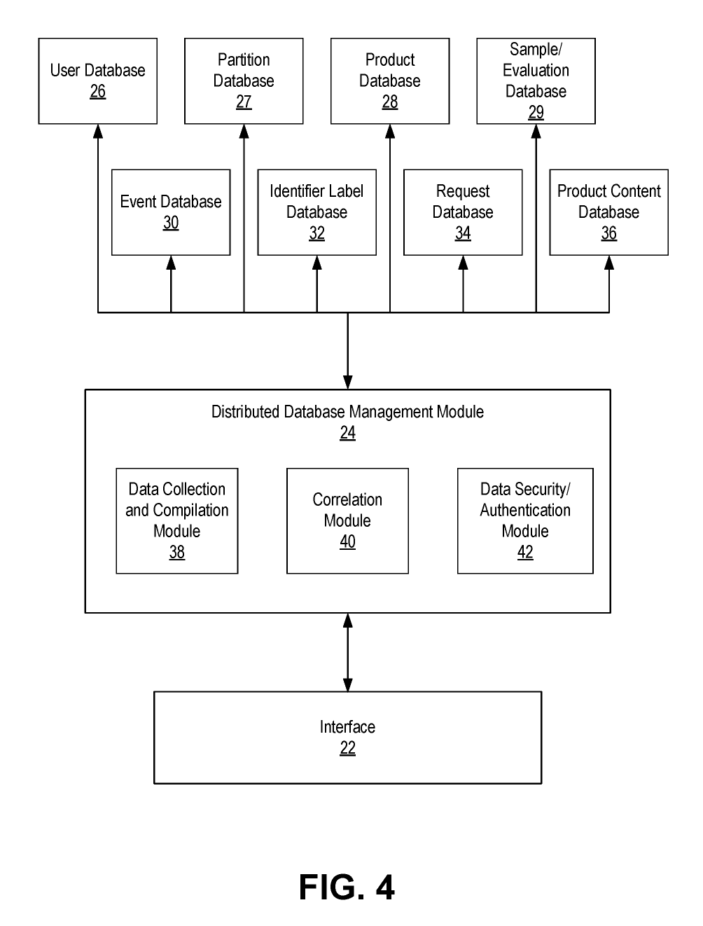

The distributed database management module 24 is configured to manage the exchange of data between users 16 and the system 12 so as to provide traceability of a product as it moves through a supply chain as well as allow supply chain management. The distributed database management module 24 is further configured to manage access to data stored on the various databases 26-36. FIG. 4 is a block diagram illustrating the distributed database management module 24 in greater detail.

For example, as an initial step, a user 16 attempting to gain access to the system 12 may be required to verify that they are registered with or otherwise allowed access to data provided by the system 12. The user database 26 may generally be used for the storage of a profile or account associated with a user. Accordingly, a user 16 may first be prompted to either login to an existing user profile or account stored in the user database 26 or to create a new account or profile. It should be noted, however, that an administrator associated with the system 12 (e.g. a third-party administrator) may have control over user access, determining who may have access and the level of access permitted. Additionally, the administrator may be able create a user profile or account or modify and existing profile or account. A user account or profile may generally include conventional input (e.g., user identity, user location or address, background information, role in supply chain, preferences, login credentials, etc.). It should further be noted that the distributed database management module 24 may further be configured to limit user access to certain data based on user credentials (e.g., role-based access). For example, a farmer may have limited access to the type of supply chain data versus the amount of access provided to a producer in the supply chain. It should be noted that in some instances, a user need not necessarily have an account or profile in order to access specific data. For example, a consumer may not have to be registered with the system 12 in order to access traceability information associated with a product they purchased or are interested in purchasing. Instead, the distributed database management module 24 may be configured to recognize the user's role (e.g., a consumer) and further limit access to traceability data.

User access may also be limited based on a specific group that the user is designated as belonging to (group-based access) or a specific jurisdiction under which the user is governed. For example, in some embodiments, the various components of the integrated supply chain system 12 may be operated by different independent agencies. The system 12 is configured to allow data resources comprising the integrated supply chain to be partitioned and distributed among different physical systems, yet to communicate and interoperate with one another via the distributed database management module 24.

For example, as coffee is produced in at least 40 countries worldwide, such coffee-producing nations may consider information related to the production and trade by their citizens to be sovereign and subject to policies of their own design. Accordingly, the system of the present invention, using the capacities for distribution described herein, allows for the integrated supply chain to be segmented in such a way that an individual nation is able to store and operate a partition of the integrated supply chain independently.

For example, as shown in FIG. 2 and previously described herein, the system may include multiple remote servers 20(1)-20(n), each of which is tied to a corresponding user 16(1)-16(n), which may be different members or entities of the supply chain. For sake of simplicity, each remote server 20 may be tied to a particular nation. For example, in the instance of coffee, a first remote server 20(1) may be associated with Ethiopia 16(1), and a second remote server 20(2) may be associated with Uganda 16(2), and so on. Each of the remote servers 20 may be configured to communicate and exchange data directly with one another via peer-to-peer communication. Thus, each remote server 20(1)-20(n) includes its own integrated supply chain system 12(1)-12(n) which includes similar components (e.g., distributed database management module 24, one or more databases 26-36, etc.) and functions in a similar manner. The integrated supply chain systems 12(1)-12(n) allow each associated user 16(1)-16(n) to manage and communicate with multiple databases under its own control. In addition, each will have an identical capacity to locate and communicate directly with its peer remote servers and negotiate access to traceability data maintained by the other peer remotes servers.

Accordingly, each nation may have some form of control or management over their corresponding remote server, particularly control over the exchange or sharing of data from the remote server with other remote servers. Similarly, a private entity operating a remote server linked with the entity's internal information systems may exercise control over the exchange or sharing of data.

In some embodiments, the systems and methods of the present invention may allow a private entity operating a remote server linked with the entity's internal information systems to exercise control over the exchange or sharing of data. For example, a distributed repository controlled by an entity may expose an enhanced or customized functionality allowing the data contained in the repository to be accessed or manipulated by the controlling entity for purposes of linking the traceability data more closely with the entity's internal information systems.

In an exemplary embodiment, a first user 16(1) accessing their remote server 20(1) via an associated integrated supply chain system 12(1) may attempt to provide data (e.g., scan a barcode label to provide tracking information of a product). In this instance, the data may be tied to a specific nation and thus may be subject to the security policies and procedures outlined by the nation. Accordingly, during an exchange or attempted exchange of such data with the system 12(1), the system 12(1) (e.g., the distributed databased management module 24) may be configured to identify data type (e.g., identify the corresponding nation to which the data is associated) and further allocate or partition such data into the specific remote server associated with the nation to which the data belongs.

Allocation of data into the remote servers may be based on specific access policies and procedures designed and controlled by each nation. The integrated supply chain system design allows the partitioned data to be fully functional and interoperable with all other partitions and components of the integrated supply chain. Furthermore, systems and methods of the present invention are configured to validate the data integrity of such allocated or partitioned data so as to provide credible assurances to external parties that the data maintained within the segmented partition has not been altered by accident or design. Toward the implementation of these features, data associated with any traceable unit may comprise data of a particular format designating the remote server (or partition) where part or all of the first data is to be maintained and accessed. The partition database 27 may include a list of all partitions registered with the integrated supply chain system 12, such that the distributed database management module 24 may refer to the partition database 27 to determine the authenticity of data for any given partition. For example, for each entry of a partition, a corresponding URL may be used in accessing or manipulating data from that partition. Access of such partitioned data may be granted based on the nation's specific security policies and procedures under which the remote server operates. For example, a user may have to be registered with a remote server, or otherwise be designated as authorized to obtain access to data on the remote server, in order to access partitioned data.

Accordingly, a coffee roaster in Seattle, upon receiving a shipment of coffee from Ethiopia, might request traceability data for each of the bags of coffee in that shipment upon arrival. The request would be initiated through an instance of the system serving the western

United States, for example, and from there routed to an instance of the system situated in Ethiopia and maintaining a partitioned repository of data under the control of the Ethiopian government. The data relevant to the request may be routed directly to the requestor, or it may be passed to yet a third intermediate instance of the system where it may be validated by an independent third party prior to being delivered to the requestor.

For example, in the normal course of supply chain activity, a product may transfer from one user 16(1) to another user 16(2). In following with the above example, a lot of coffee may originate in the national repository of Ethiopia and then be transferred to a buyer, such as a retailer 16(2). Accordingly, such a transfer may include a transfer in ownership or a transfer of custody over the lot of coffee. In this instance, because the transferring user 16(1) (Ethiopia) and receiving user 16(2) (Retailer) are associated with different privately-managed repositories or databases via respective remote servers 20(1) and 20(2), the transfer of the lot of coffee further requires the transfer of the traceability data of the coffee lot. As will be described in greater detail herein, the system 10 of the present invention is configured to provide for the secure transfer of the coffee lot's traceability data between the first and second remote servers 20(1) and 20(2) upon transfer of ownership or custody of the coffee lot and further provide validation systems and processes configured to ensure that such transfers are valid (e.g., verifying identity of receiving entity and associated receiving database and further verifying authorization of receiving entity for access to data to be transferred) and further validating the integrity of the data to be transferred (e.g., ensure that data is not compromised).

Once a user is verified to be registered with the system, the user may have a variety of options to choose from. For example, a user may wish to input data into their respective system 12 related to the product they are handling at a current point along the supply chain. The data may include information related to the user, information related to the product, as well as information related to an event associated with the product. For example, the product may be a food product, such as coffee, and the user may be a coffee producer. The coffee producer may be responsible for a certain activity or process along the coffee supply chain. As will be described in greater detail herein, a coffee producer may be responsible for purchasing coffee cherry from a set of arbitrary farmers and processing the coffee cherry into parchment coffee. Upon generating parchment coffee and subsequently bagging the parchment coffee, the coffee producer will input data related to the bagged parchment coffee. More specifically, the producer will generally use an identifier label for the bagged parchment coffee for tracking the parchment coffee as it moves through the supply chain. The identifier label may include a unique identifier, such as a digital representation of a machine-readable label, such as text, graphics, an image, a linear barcode, a matrix barcode, or the like. Accordingly, the coffee producer may use a device equipped with necessary component to scan the identifier label and subsequently transmit the digital representation of the unique identifier to their system 12.

Upon receiving the digital representation, the distributed database management module 24 is configured to receive and/or compile data associated with the identifier label. For example, the distributed database management module 24 may include a data collection and compilation module 38. The data collection/compilation module 38 is configured to decode the digital representation, collect or identify the data associated therewith, and further compile the information into the respective databases 26-36. For example, the identifier label of a bag of parchment coffee may include information related to the coffee producer and/or farmers who produced coffee cherry, information related to the parchment coffee, information related to the supply chain event (e.g., processing of coffee cherry into parchment and bagging of parchment coffee). This information may be previously inputted into the system 12 by the coffee producer or administer, or other user, and pre-assigned to the specific identifier label used in tagging the bag of parchment coffee or the information may be inputted on-the-fly.

Accordingly, the product database 28 may generally be used for the storage of profiles associated with products, wherein each profile includes information related to an identity of a product or unit of product, characteristics of the product or unit of product, location of the product or unit of product, characteristics of the location. The characteristics of the product or unit of product may include, for example, physical attributes of the product or unit of product, origin of the product or unit of product, destination of the product or unit of product, and a combination thereof. Similarly, the characteristics of the location of the product or unit of product may include the operator of the location, overall capacity of the location, current capacity of the location, seasonality of the location, operational status of the location, current weather at the location, and a combination thereof.

As generally understood, quality assurance through sampling and evaluation is an important aspect of a traceability system in its functions of isolating and tracking contamination events and other quality issues. Accordingly, the sample and evaluation database 29 may generally be used for the storage of profiles associated with product samples and corresponding evaluations of such samples. A user may create samples of a product unit and submit such samples for evaluation at any point along the supply chain. In the instance of coffee, for example, coffee beans may be evaluated and graded during certain phases of production (e.g., parchment coffee, green coffee, roasted coffee, etc.). These samples and one or more evaluations may be registered in the sample/evaluation database 29 with links to the corresponding records in the user database 26, product database 28, and event database 30, according to the product unit sampled, the event, and the users performing the activities.

Furthermore, registered samples may be assigned unique identifiers, registered in the identifier label database 32 as a distinct class of traceable unit, and labeled accordingly. In the coffee supply chain, for example, samples of coffee are routinely passed among all members of the supply chain during production and transaction processes, including parchment samples, pre-shipment samples, reference samples, shipment samples, and arrival samples. Upon receiving a labeled sample, a member of the supply chain can immediately trace the sample to the individual units from which it was drawn and know their provenance and passage through the supply chain. Similarly, upon receiving a traceable product unit, a user may immediately access all samples and evaluations related to that unit, including all samples and evaluations drawn at any point in the supply chain, and also encompassing samples and evaluations pertaining to the peers, progeny, or progenitive units associated with that product. Furthermore, trading of any given unit of product may be based, at least in part, on the evaluation data. For example, the price for a unit may be dictated by the grading of a sample, as determined by the commodity exchange.

The event database 30 may generally be used for the storage of profiles associated with events tied to any given product or unit of product. An event may include, for example, any activity or process occurring along the supply chain by one or more members of the supply chain. For example, an event may include a transaction between members of the supply chain, such as the sale of coffee cherry from a farmer to a producer, or the sale of a cup of coffee from a retailer to a consumer. Accordingly, each event profile may include transactional data related to an exchange of the product between members of the supply chain, data related to a process or activity involving the product, or the like. The transactional data may include the identity of members of the supply chain associated with the exchange of the product, quantity of product exchanged, price paid for the product, date of the exchange of the product, and a combination thereof.

The identifier label database 32 may generally be used for the storage of profiles associated with identifier labels, wherein each profile may generally include information related to the identifier label, such as the identity of the identifier label, as well as all information to be associated with or assigned to the identifier label (such information including user information, product information, and event information from databases 26-30). Accordingly, the distributed database management module 24 is configured to manage the correlation of data between databases 26-36 so as to provide associations there between for tracking purposes. For example, when an identifier label is scanned and the digital representation is transmitted to the system 12, data associated with the identifier label is retrieved by the distributed database management module 24 and compiled for access by a user. Furthermore, two or more identifier labels may be associated with one another, wherein data corresponding to each of the identifier labels may be correlated so as to provide traceability of the product, as will be described in greater detail herein. More specifically, as shown in FIG. 4, the distributed database management module 24 further includes a correlation module 40 configured to correlate two different sets of data with one another. The correlation module 40 may include custom, proprietary, known and/or after-developed statistical analysis code (or instruction sets), hardware, and/or firmware that are generally well-defined and operable to receive two or more sets of data and identify, at least to a certain extent, a level of correlation and thereby associate the sets of data with one another based on the level of correlation.

As referred to herein, correlation analysis may generally refer to the associating of two sets of variables (e.g., two different barcode tags) with each other. In the instance of a supply chain, correlation analysis may include establishing connections between two sets of variables (between at least two events occurring along the supply chain). Exemplary techniques for performing correlations are described for example in Hotelling, H., “Relations Between Two Sets of Variates”, Biometrika, 28 (3-4): 321-377, 1936; Hsu et al., “A spectral algorithm for learning Hidden Markov Models”, Journal of Computer and System Sciences, 78 (5): 1460, 2012; Hardie et al., “Canonical Correlation Analysis”, Applied Multivariate Statistical Analysis, pp. 321-330, 2007, the content of each of which is incorporated by reference herein in its entirety. Exemplary correlation analysis systems and methods are discussed in greater detail in Techniques for Reconstructing Supply Chain Networks Using Pair-Wise Correlation Analysis, U.S. Pat. No. 7,433,857 to Rice et al., the content of each of which is incorporated by reference herein in its entirety.

In some embodiments, the system 12 uses network modeling techniques to model relationships between associated sets of data and further uses network traversal techniques to retrieve complex patterns of associated data quickly and efficiently. For example, the correlation of sets of data with one another may be based on direct observation. For example, when parchment coffee undergoes a milling process, individual units of parchment coffee may be scanned (e.g., scanning of barcoded identifier label) as they are loaded into the mill, thus creating an aggregate unit, or “mill lot”, with all contributed units associated with one another based on the scanning event. When the resultant green coffee is re-bagged, the units are directly linked to the green coffee lot and the green lot is directly linked to the “mill lot.”

Correlation and statistical algorithms may further be relied upon as a means of facilitating handling of units during certain processes or activities along the supply chain, such as warehouse handling. For example, when a lot is received at a warehouse, rather than scanning the identifier label of every unit individually as it is loaded into the mill, the warehouse operator seeks to cut costs by scanning a sample unit of the total set of units. The system 12 is configured to utilize statistical analysis algorithms to determine the probability that the sample accurately reflects the identity of the lot and more importantly, provide a level of confidence that the lot is intact and all the units that have not been scanned will belong to the same identified lot.

The system 12 of the present invention is further configured to receive requests from certain users 16 (e.g., a retailer or seller) who wish to provide product traceability information, as well as other types of information, to a consumer who purchased or is interested in purchasing the product. More specifically, a seller may wish to provide dynamic content to a consumer at the point of sale or delivery, wherein such dynamic content may be specific to details about the specific product sold, the circumstances of the transaction, or the identity of the consumer. The dynamic content may be stored in the product content database 36, wherein the seller may have access to such database and can assign or modify the content to be associated with the product sold or to be sold, which is discussed in greater detail herein.

As previously described, the integrated supply chain management system 12 is integrated in the sense that multiple users are able to contribute and draw information from the system so as to improve visibility of traceability data, even in the event that users are not part of the same organization or business entity. In some embodiments, access to supply chain data of a given product (e.g., product traceability data, identity of users associated with product supply chain, etc.) may be controlled based on established relationships or connections between one or more users. For example, users in a supply chain may be part of a group based on or more common characteristics that they share, such as, their role in the supply chain, their relationship with other user's in the supply chain, their assigned level of access to data, as well as specific designation into one or more groups as decided by an administrator, or other user, having authority to define a user's level of access or assign a user to a specific group. Accordingly, the system 12 may be configured to allow a user access to specific sets data based on the one or more groups that the user is a member of. For example, the system 12 may include one or more access plans for a specific group, wherein an access plan generally includes a set of data accessible to a user associated with the group to which the access plan corresponds.

The group-based access may be similar to those implemented in social networking platforms. For example, users, such as producers, may be part of a group based on their role in a supply chain. Accordingly, the system 12 may allow producers in that group to access a specific set of data based on their membership to the group. The specific set of data may include, for example, the profile of other producers within that group, including the identity of the producer, the producer's location, the producer's production history, including current supply chain events as well as prior supply chain events, for any given product. Accordingly, the system 12 may allow a user to view statistical information of another user. In addition to providing access to non-critical data (e.g., statistical data and the like), the system 12 may assign access plans to users of a group having authority to view and/or modify confidential or critical data, such as transactional data (e.g., order requests, assignment of orders, etc.). For example, a select few users may have the authority to manipulate supply chain data so as to control events and activities tied to the supply chain of a product. For example, specific users in a supply chain (e.g., producer, exporter, retailer/buyer, etc.) may have the authority to dictate certain aspects of the supply chain, such as transactional aspects of a product in the supply chain (e.g., purchase price, quantity, timing of delivery or sale, etc.). Such users may be assigned membership into an exclusive group. The system 12 is configured to provide an access plan directed to such an exclusive group, wherein access to the previously described critical data can be limited to the exclusive group, such that only those members have access.

It should be noted that groups may be created via supply chain management tools provided by the system 12, such that an administrator, or other user having authority to do so, can assign users to a particular group. The access plans can further be created and assigned to any given group via the supply chain management tools provided by the system 12. Accordingly, the integrated supply chain management system 12 is configured to allow users to contribute to and draw from a shared flow of data, while in a controlled and regulated manner so as to ensure security of the data.

It should further be noted that the integrated supply chain system 12 may be configured, in certain embodiments, to provide various levels of tracing and tracking services commensurate with different levels of costs, depending on the degree of “credibility” any given transaction requires. For example, some products require a high level of attention during movement through the supply chain so as to ensure authenticity of the product from point of origin to the final consumer. Some products are of such a nature that their handling must be closely monitored for purposes of safety and precaution (e.g., food products). The different levels of service may be associated with different levels of certification. For example, in one embodiment, the highest level of service (e.g., “gold standard”) may include a physical agent being sent to a given location where a process or event is occurring such that the agent may supervise that even (e.g., coffee going through the milling process). For a mid-level service (e.g., “silver standard”), a physical agent may not be sent out, but is on standby, which may cause of a degree of trust to be involved. For the lowest level of service (e.g., “bronze standard”), data may be provided with no separate certification. The different levels of service may include additional requirements that certain members of the supply chain must comply with, such as, for example, additional tracking processes (e.g., capturing images of the product at points along the supply chain or during an exchange of the product from one member to another member of the supply chain).

The system 12 may generally be aware of the level of service for any given product. Accordingly, as the system 12 is tracking products, and the like, the system is configured to further integrate the level of service certification standards. For example, the event database 30 may store a sign-in event associated with the GPS coordinates of a physical inspector at the mill site as part of a milling event. Another example may include storage of image data (e.g., timestamped and/or geo-stamped) at an event. For example, exporters may be required to photograph identifier labels on a product (e.g., bags of green coffee beans), including close-ups of the labels, upon loading a container for delivery. The images may then be uploaded to the event database 30. Accordingly, in the event that an importer receiving the shipment complains the wrong coffee was delivered or wasn't labeled, the image record is available to verify conditions at point of departure. As another example, a “circle of trust” model may be implemented among farming communities where independent producers can build a credibility score based on a set of factors. The distributed database management module 24 may include algorithms for determining the level of credibility of the traceability data for a given product based on a variety of criteria.

As shown in FIG. 4, the distributed database management module 24 further includes a data security/authentication module 42 configured to provide comprehensive security measures to allow for controlled dissemination of a product's traceability data while maintaining the integrity of a product's traceability data as a product moves through various stages of the supply chain and possibly exchanges hands multiple times. For example, as previously described herein, particularly with reference to FIG. 2, in the normal course of supply chain activity, a product may transfer or be assigned from one user 16(1) to another user 16(2). Such a transfer or assignment may include a transfer in ownership or a transfer of custody over the product. As part of the product transfer, the product's traceability data will also be transferred from a first privately-managed data repository of the first server 20(1) to a second privately-managed data repository of the second server 20(2). However, prior to transfer of the traceability data, the data security/authentication module 42 is configured to ensure that such transfers are initially valid and further configured to validate the integrity of the data to be transferred.

For example, as part of the validation process for transfer of data, the data security/authentication module 42 may authorize the transfer based on a validation of the receiving user's identity or other credentials. This may involve a comparison of receiving user data with assignment data (e.g., determine whether receiving user identity matches the identity of the one of the users involved in product transfer) or other forms of identity validation. The process of data validation and transfer from one privately-managed repository to another privately-managed repository across the distributed network is described in greater detail herein.

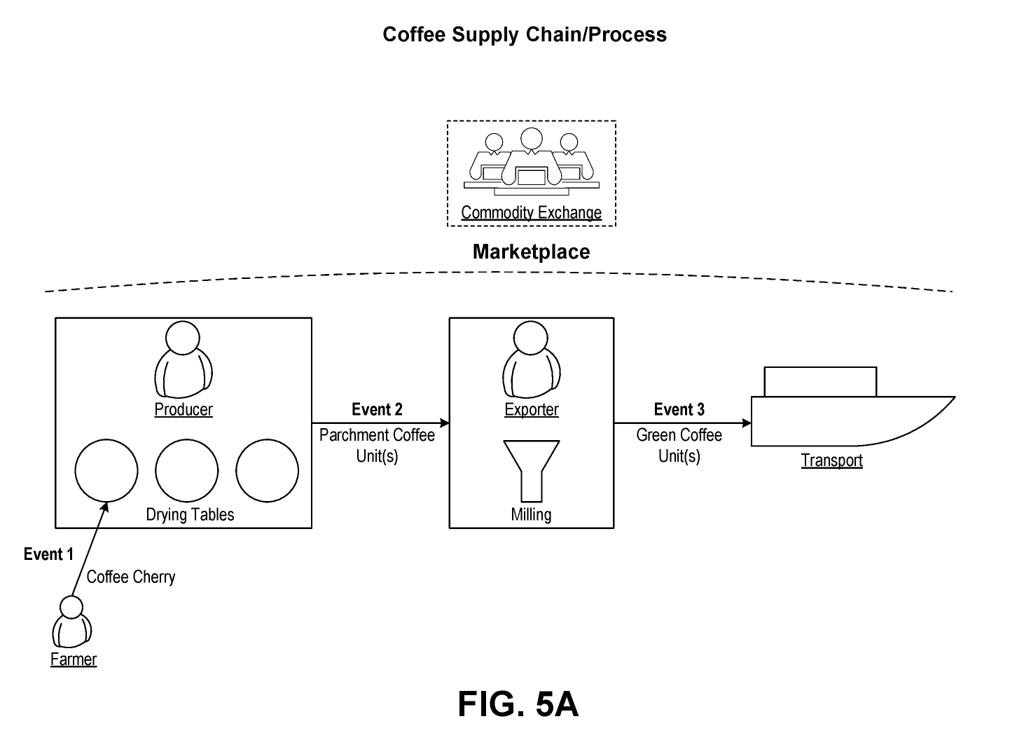

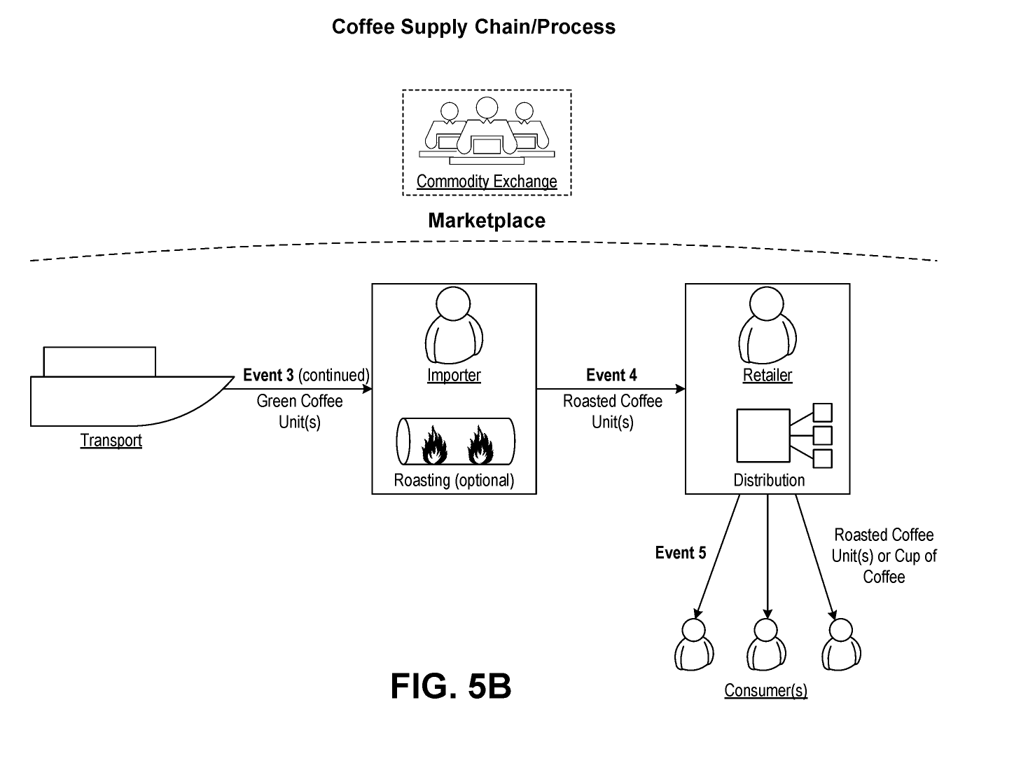

A particular exemplary embodiment of systems and methods of the invention is described in FIGS. 5A and 5B, which illustrate a continuous flowchart of an exemplary supply chain for coffee. For coffee, the supply chain is often complex, and varies in different countries. The various members of the supply chain may include, for example, the farmers or growers, intermediaries, such as producers and exporters who perform much of the processing, as well as importers, suppliers, transporters, retailers, and the like, who may be involved in one or more events required to bring a coffee bean from its raw state through to a finished state to be delivered to the consumer or requesting customer. As previously described, coffee is generally considered a traded commodity in most countries. Accordingly, another entity that may play a role in the coffee supply chain process is a commodity exchange, which generally facilitates trade by providing a fluid and stable market for food or other products, as will be described in greater detail herein. Referring to FIG. 5A, upon harvesting coffee cherries, farmers will generally sell their harvest to a producer or other intermediary (Event 1). Intermediaries, such as producers, processors, exporters, and the like, may buy coffee at any stage between coffee cherries and green beans and they may further perform some of the primary processing, or they may collect together sufficient quantities of coffee from many individual farmers to transport or sell to a processor, another intermediary, or to a dealer. There may be as many as five intermediary links in the chain.

For sake of simplicity, and ease of description, FIG. 5A illustrates sale of coffee cherries from a farmer to a producer. The farmer may generally work on a very small plot of land of just one or two hectares, for example. Many farmers may undertake primary processing (drying or hulling) themselves. However, for the most part, intermediaries, such as the producer and exporter, will perform much of the processing. The producer may begin the processing of the coffee cherries, either by a wet process or a dry process, so as to obtain a parchment coffee product. In the wet process, the fruit covering the seeds/beans is removed before they are dried. Coffee processed by the wet method is called wet processed or washed coffee. After the washing process, the beans are dried in the sun or by machine. When dried in the sun, coffee is most often spread out in rows on large patios where it needs to be raked every six hours to promote even drying and prevent the growth of mildew. Some coffee is dried on large raised tables where the coffee is turned by hand. The drying operation is an important stage of the process, since it affects the final quality of the green coffee.

Upon drying the cherries (now parchment coffee), the producer may store the parchment coffee in bulk until an order is placed in which units of parchment coffee may be transferred to an exporter (Event 2). The units of parchment coffee may be sent to a mill where hulling, sorting, grading, and bagging takes place to create units of green coffee. The units of green coffee may be transported in jute bags, for example. The units of green coffee are then transported to an importer, for example (Event 3). The importer may also be responsible for roasting the green coffee. However, it should be noted that green coffee may travel through the remainder of the supply chain to be sold to a consumer for roasting at home. The units of green coffee may alternatively be provided to a dealer or broker who is responsible for supplying the green coffee to roasters in the right quantities, at the right time, at a price acceptable to buyer and seller. The importer may then provide roasted coffee to the retailer (e.g. the seller of the coffee product) (Event 4). The roasted coffee may be sold to the retailers in bulk, at which point the retailers than distribute the bulk quantity into smaller consumer-size portions for sale at a consumer level. Alternatively, the roasted coffee may be provided to the retailers in smaller consumer-size portions for sale at a consumer level. Retailers may include, for example, large supermarkets, independent coffee retailers, hotel and catering organizations, and the like. The retailers may then sell either units of roasted coffee (e.g., 12 ounce bags of roasted coffee beans) or sell cups of brewed coffee to consumers (Event 5).

The commodity exchange generally functions by aggregating similar units of a product into well-defined categories, allowing units within each category to be traded as equivalents (e.g., commodities). A single market price governs transactions of a classified product at a given point in time. Producers and traders may benefit from a single, known price they can access for a given product. In the present example, coffee may generally be traded through the commodity exchange, which generally acts as a marketplace that serves all market actors, from the farmers to traders to processors to exporters to consumers. Most of the coffee in Ethiopia, for example, is traded through the Ethiopia Commodity Exchange (ECX) for example, with units assigned to approximately 100 classifications based on quality and geographic region of origin. A commodity exchange may be important and relied upon by members of the market due to its ability to disseminate data to all market actors, through clearly defined rules of trading, warehousing, payments and delivery and business conduct, and through an internal dispute settlement mechanism. The commodity exchange may provide market integrity at different levels, including the integrity of the product itself, the integrity of the transaction, and the integrity of the actors involved.

Despite its benefits, the commodity exchange may present a challenge for traceability. The principle of equivalence underlying the market requires the removal of certain information, such as the identity of the producer. The systems and methods of the present invention allow a product to be traded through a commodity exchange market structure without compromising this principle of equivalence, so long as the traceability up to the point of trade is retained. The information may be hidden, such that a buyer trading in an exchange is unable to select individual units from a known producer at the time of a transaction. However, the identifier labels (e.g., barcoded tags) associated with each unit of coffee, for example, may pass through the market, and allow full traceability to the supplier(s) of the traded units to be made available after the transaction is complete.

In some embodiments, systems and methods of the present invention further provide for an online global marketplace in which certain members within the supply chain can share product information with other members as a means of offering the exchange of a product (i.e., the sale or trade of the product). In other words, the global marketplace may allow for certain members (e.g., sellers) to present a registered product (e.g., product lots, one or more units in a product lot, etc.), as well as associated data (e.g., sampling and evaluation scores) directly to other members (e.g., buyers) via on online forum.

In the instance of coffee, the system of the present invention allows for certain supply chain members (e.g., farmer, producer, importer, distributor, etc.) to select any given unit of a coffee product lot, or an entire coffee product lot, to be presented via the global marketplace and to further select which coffee information is viewable by other members having access to the global marketplace. In particular, a member may utilize the integrated supply chain system 12 associated with their respective privately-managed repository to control access to product information and data stored within the repository for any given registered coffee product lot. For example, the system 12 may include one or access plans from which the associated member may choose to implement so as to limit the amount of access that other members may have to the product information and data of any given coffee product lot.

For example, a farmer may wish to offer registered lots of coffee cherries to a producer via the marketplace, or a producer may wish to offer registered lots of parchment or green coffee to an importer or distributor, and so on. The systems of the present invention allow for the farmer or producer, for example, to select specific lots of their coffee product, as well as the specific product information associated therewith, to be presented to potential buyers via the online global marketplace. The specific product information may include, for example, the identity of the coffee product, including characteristics of the coffee product, the origin of the coffee product, the amount and price of the coffee product, as well as some traceability information of the coffee product, such as, processing of the coffee product, storage of the coffee product, and movement of coffee product from one location to another location. In some embodiments, product information that may be critical to the sale or trade of the coffee product via the global marketplace may include sampling and evaluation of the coffee product. For example, a seller may wish to further include a grading score of their coffee product or a cupping score, which is used for assessing overall quality of the coffee product.

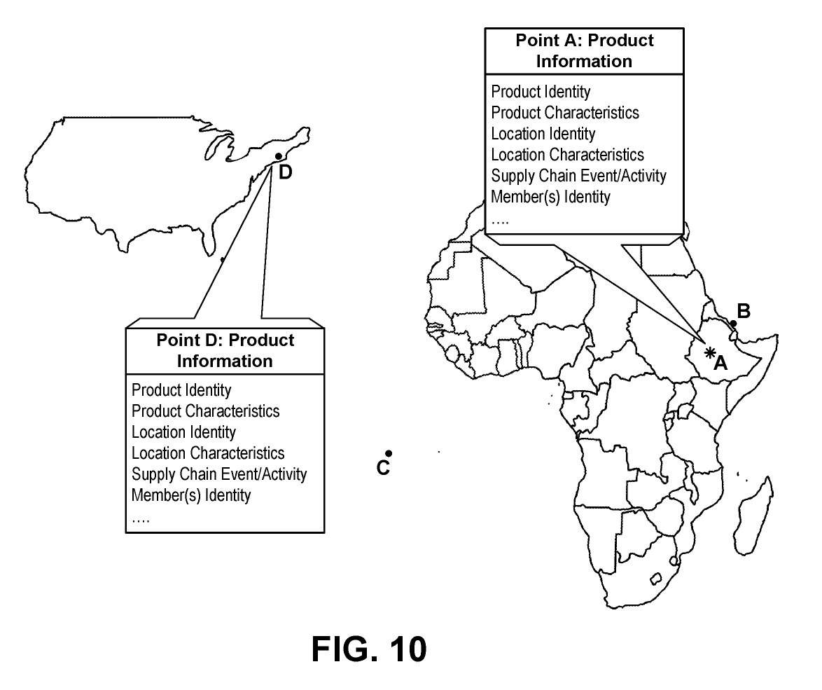

As previously described, the interface 22 of the integrated supply chain system 12 is configured to present product information to a user 16 via a user's computing device based, at least in part, on data received by the system 12. Thus, in some embodiments, the system 12 is configured to output the global marketplace, including specific product lots and associated product information, to a user (e.g., buyer) in the form of a visual representation, such as an image or illustration, with which the user may interact via their GUI on their user device so as to view details regarding the product lots and product information. For example, the system 12 may be configured to output market lots on a map based on origin of the product lot, at which point, users may interact with the map to choose which product lot is of interest and further access the product information made available to them. As shown in FIG. 10, for example, a user may be presented with a map that includes various geographic locations which may include available product lots offered for sale or trade.

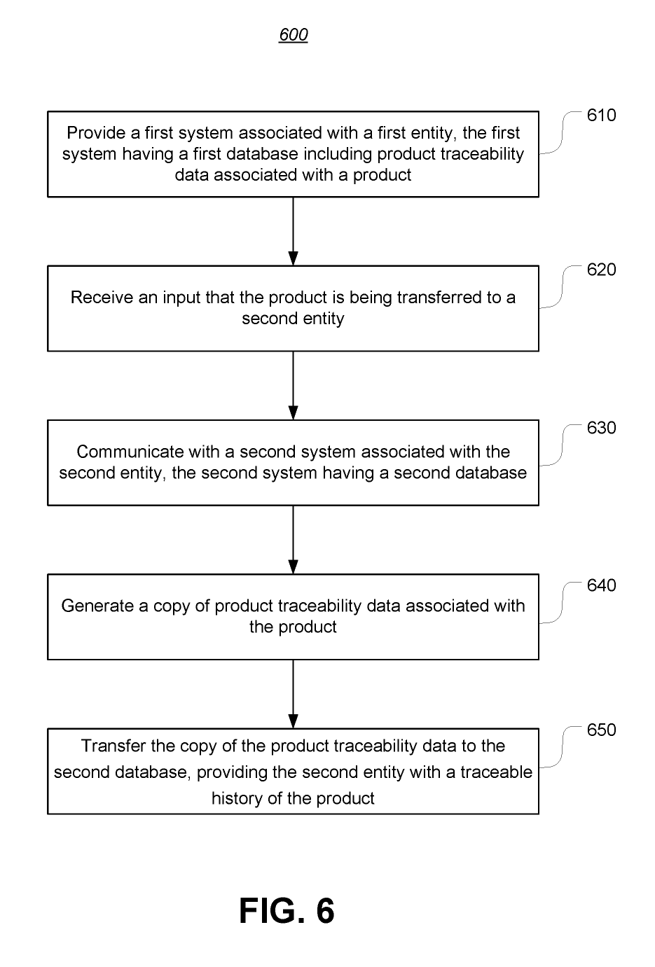

The following flow diagram of FIG. 6 illustrates a method 600 for managing product traceability data of a product that is moving among entities in a supply chain. The method 600 of FIG. 6 generally directed to coffee products. It should be noted, however, that the following method described herein is applicable to various products, goods, services, and the like, are not limited to coffee.

Aspects of the invention are able to provide comprehensive data segregation and security measures to allow for controlled dissemination of a product's traceability information and further allow for maintaining the integrity of a product's traceability information as the product moves through various stages of the supply chain and possibly exchanges hands multiple times.

FIG. 6 is a flow diagram illustrating one embodiment of a method 600 for managing product traceability data of a product that is moving among entities in a supply chain. The method 600 includes providing a first system associated with a first entity, wherein the first system has a first database including product traceability data associated with a product (operation 610).

In some embodiments, the product traceability data may include a unique identifier associated with the product. In some embodiments, the unique identifier is associated with a tag associated with the product. The tag may include a digital representation of a machine-readable label or indicia. For example, the machine-readable label of indicia may include, for example, text, graphics, an image, a linear barcode, a matrix barcode, an RFID element, and a combination thereof. In some embodiments, the product may include a product lot including one or more product units. Thus, each of the one or more product units may have a tag associated therewith, wherein the product traceability data includes a unique identifier associated with each tag.

In some embodiments, the product traceability data includes product information including, but not limited to, an identity of the product, characteristics of the product, location of the product, characteristics of the location, traceability information of the one or more product units, transactional data related to one or more exchanges of the one or more product units, and a combination thereof. The characteristics of the product may include, for example, physical attributes of the product, origin of the product, destination of the product, and a combination thereof. The characteristics of the location of the product may include, for example, an operator of the location, overall capacity of the location, current capacity of the location, seasonality of the location, operational status of the location, current weather at the location, and a combination thereof. In some embodiments, the traceability information may generally include supply chain activities or events associated with the product. The supply chain activities or events may include, for example, processing of the product, storage of the product, movement of product from one location to another location, sampling of the product, evaluation of the product, and a combination thereof. The transactional data may include, for example, an identity of one or more entities associated with the exchange of the product, a quantity of the product exchanged, a price paid for the product, a date of the exchange of the product, and a combination thereof.

The method 600 further includes receiving an input that the product is being transferred to a second entity (operation 620). The input that the product is being transferred may include, for example, assignment data associated with an assignment of the product from the first entity to the second entity. The assignment data may include, but is not limited to, identity of the first and the second entities, type of assignment, consideration exchanged as part of the assignment, date and time of the assignment, and a combination thereof.

Upon receiving the input that the product is being transferred, the first system communicates with a second system associated with the second entity, wherein the second system includes a second database (operation 630). In some embodiments, the first database and the second database are part of a distributed network. In some embodiments, the first and second databases are each restricted-access databases. For example, access to information stored within may be restricted and thus may only be accessible by way of permission protocols and the like. It should be further noted that the first and second databases may be separated from one another by one or more intermediate databases.

The method 600 further includes generating a copy of the product traceability data (operation 640) and transferring the copy of the product traceability data to the second database (operation 650). By receiving the copy of product traceability data, the second entity is provided with a traceable history of the product without the second database having to query the first database.

While FIG. 6 illustrates method operations according various embodiments, it is to be understood that in any embodiment not all of these operations are necessary. Indeed, it is fully contemplated herein that in other embodiments of the present disclosure, the operations depicted in FIG. 6 may be combined in a manner not specifically shown in any of the drawings, but still fully consistent with the present disclosure. Thus, claims directed to features and/or operations that are not exactly shown in one drawing are deemed within the scope and content of the present disclosure.

Additionally, operations for the embodiments have been further described with reference to the above figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited to this context.

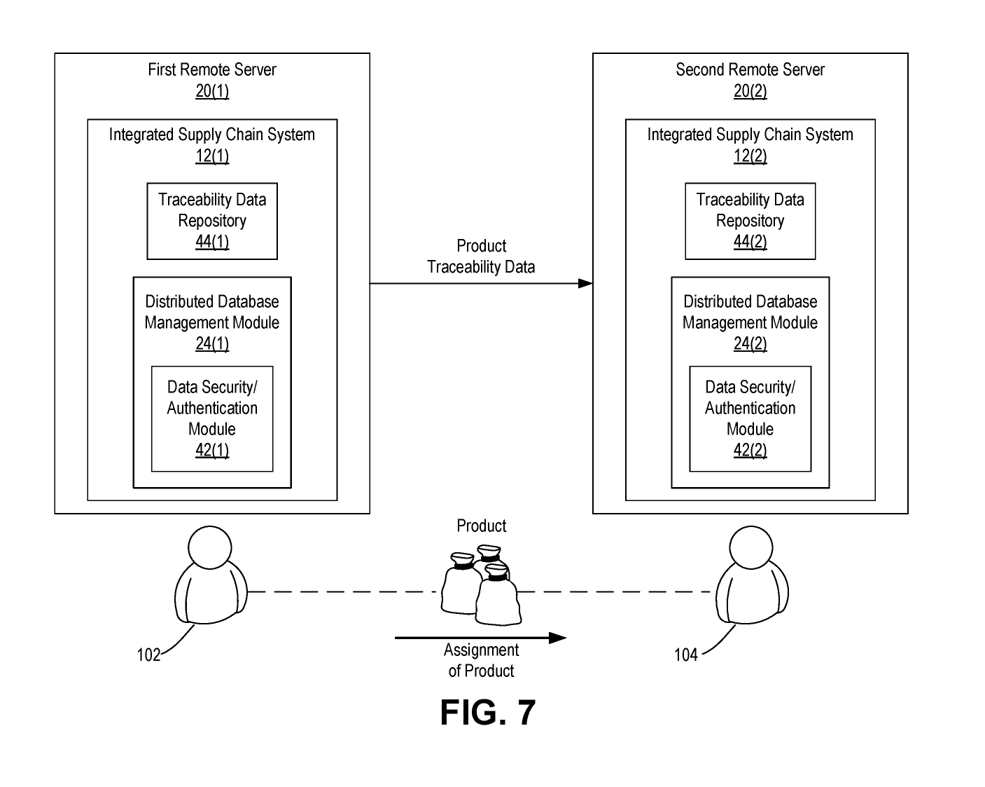

FIG. 7 is a block diagram illustrating an exemplary system for managing the exchange of a product's traceability data between privately-managed databases across a distributed network based on the transfer of the product between entities associated with the privately-managed databases. As shown, a first entity 100 and a second entity 102 may each be associated with respective remote servers 20(1) and 20(2) and may be provided with complete control over independent and privately-managed data repositories or databases across the distributed network via respective integrated supply chain systems 12(1) and 12(2) associated with each remote server 20(1) and 20(2). For example, the first entity 100 may have control over a first traceability data repository 44(1) and the second entity 102 may have control over a second traceability data repository 44(2), wherein the first and second traceability data repositories 44(1) and 44(2) are each configured to store traceability data of a product. In other words, the first entity 100 and second entity 102 are able to manage the dissemination of traceability data in their respective repositories 44(1) and 44(2) (e.g., determine what data is disseminated and to whom it is disseminated to). For example, in the distributed network, there may be many remote servers 20 having associated data repositories, each of which may be configured so as to share a portion of traceability data (e.g., public data) according to permissions granted by their associated members or entities, and each may further limit access to privileged traceability data (e.g., private data) according to local access control policies or permissions.

Upon assignment of a product from the first entity 100 to the second entity 102, which may include transfer of ownership or custody of the product, traceability data of the product may be copied and transferred from the first traceability data repository 44(1) to the second traceability data repository 44(2). Upon receiving the copy of product traceability data, the second traceability data repository 44(2) is effectively provided with a traceable history of the product without requiring the need for the second traceability data repository 44(2) to have to query the first traceability data repository 44(1) so as to determine any repositories-of-origin. For example, in some embodiments, the first and second entities 100 and 102 may be separated by one or more intermediate entities in the supply chain. Accordingly, the traceability data associated with the product being assigned from the first entity 100 to the second entity 102 may generally include a history of all assignments of the product between entities, and thus further includes a corresponding history of all repository transfers (i.e., transfer of traceability data between repositories in the distributed network). By generating and transferring a copy of product traceability data to a receiving database associated receiving entity each time a product is transferred among entities (e.g., transfer from first database to second database), the receiving database is able to generate a complete a complete history of the product without the need to issue requests to other databases across the network in the event a user initiates a query.

In some embodiments, the systems and methods of the present invention may generally be designed as a global service, in which all repositories share a centralized “identity server.” This “identity server” may guarantee that each traceable object in a supply chain is provided a unique identity, even if it may span multiple repositories due to multiple product assignments. The centralized “identity server” service generally operates based on the generation of an identification code. Regardless of which repository produces a traceable entity, the traceable objects identification code will be unique across the entire system. Identification codes may generally be associated with the traceable objects repository-of-origin. In some embodiments, a four-digit repository identification code system may be implemented, constructed on a base-30 numbering scheme, which will support up to 810,000 repositories. As the system approaches this limit, an additional digit will expand the range to 24 million. The first digits of an identification code may indicate the traceable object's repository-of-origin. For example, the identifier GC01-16P1-0000-0001 may represent that the traceable object originates from GC Repository Number 1.

Accordingly, the present invention provides improved data sharing among privately-managed databases across a distributed network by allowing for individual privately-managed repositories to have complete query and data analysis without triggering a complex cascade of queries, which could result in lag time and further complicate data exchange processes.

As shown, the first and second entities 100, 102 may further have access to data security measures via data security/authentication modules 42(1), 42(2), which are configured to validate the transfer of traceability data prior to transmission and to further validate the integrity of the traceability data to be transferred. The data security/authentication modules 42(1), 42(2) may be similarly configured as the data security/authentication module 42 previously described as part of the distributed database management module 24 of the integrated supply chain system 12. Accordingly, the present invention further provides comprehensive security measures to allow for controlled dissemination of a product's traceability data while maintaining the integrity of a product's traceability data as a product moves through various stages of the supply chain and possibly exchanges hands multiple times.

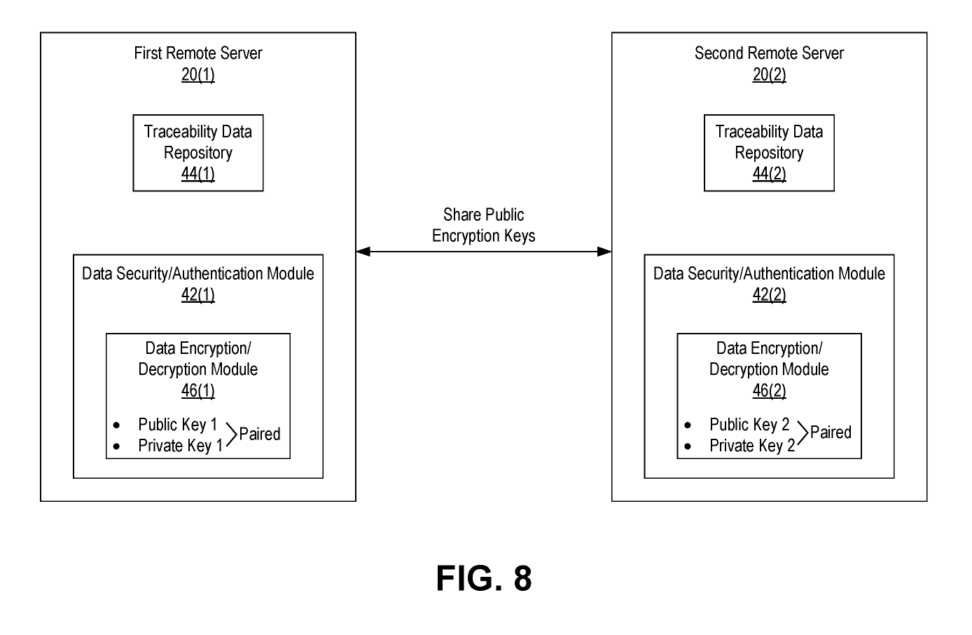

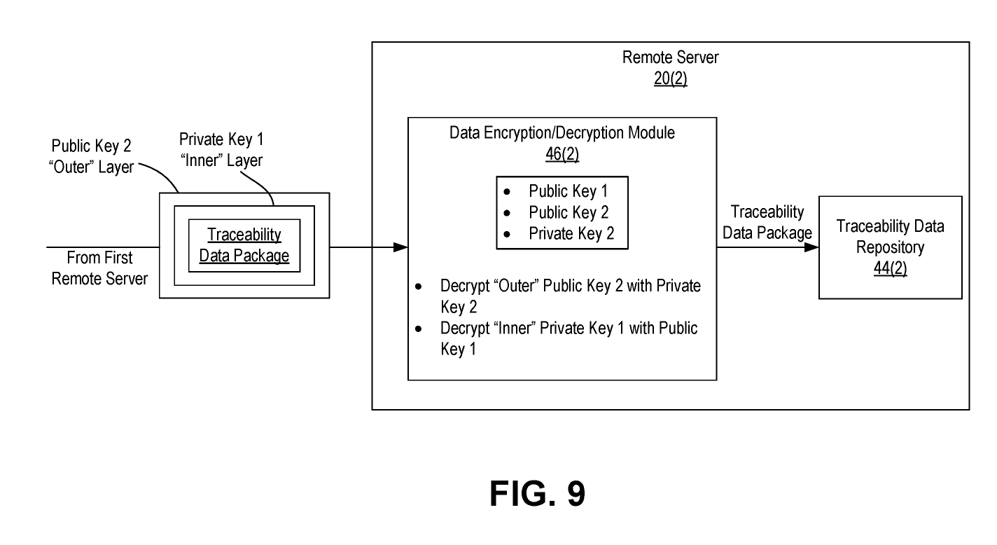

FIG. 8 is a block diagram illustrating the data security/authentication modules 42 in greater detail. FIG. 9 is a block diagram illustrating the validation of a product traceability data transfer based on the data validation processes of the system of the present disclosure.

As a matter of security, one important requirement in a distributed system is the ability to validate data transfers. The first aspect of data validation is determining whether a repository delivers the same result each time for the same request. The ability to do this is one important element in a security regime intended to prevent fraud. It is also important in maintaining up-to-date information, as some changes at origin may be valid changes of interest to the receiving repository, where, in such cases, a repository can replace obsolete data.

When data is transferred from one repository to another (e.g., from a transferring repository to a receiving repository), the transferring repository is configured to generate an encrypted “hash code”. An encrypted “hash code” is a unique 40-character digest of the transmitted data which uniquely summarizes a set of data. The receiving repository can quickly generate a hash code on the same data set, which should be identical, to determine whether data has changed in transit. In addition, the hash codes should be identical from one request to the next, wherein a change in the hash code indicates that the received data has changed. The data security/authentication modules 42(1) and 42(2) of the first and second repositories 44(1) and 44(2) may be configured to validate the integrity of traceability data to be transferred based on a comparison of the hash codes generated. In the event that the hash codes do not match, the data security/authentication modules 42(1) and 42(2) are configured to determine that the data is different, and thus may require updating or may indicate fraud.

As previously described, in the distributed network, there may be many communicating repositories, each sharing a portion of traceability data (e.g., public data) according to permissions granted by their associated members or entities, but each may further limit access to privileged traceability data (e.g., private data) according to local access control policies or permissions, which may further include data security measures, such as data validation. In the present system, each repository may be configured to generally publish a public address, in which communicating repositories present data requests to this address using a well-defined protocol. A peer-to-peer network may be used to distribute the addresses of all active repositories, similar to the DNS system used in the implementation of the Internet. In addition to publishing its URL, each repository publishes a public encryption key, as will be described in greater detail herein. Accordingly, when presented with an identification code, any repository can immediately identify the name and address of the repository-of-origin of the traceable object in question. When the local repository does not contain the required data, it passes the request to the repository-of-origin.

More generally, data transfers from one repository to another are encrypted using public/private key encryption to guarantee that the data in fact originates from the repository-of-origin and is secure along the way. This protects against “man-in-the-middle” attacks, for example, and against theft as the data moves over the Internet. For example, as shown in FIG. 8, the data security/authentication modules 42(1) and 42(2) may include data encryption/decryption modules 46(1) and 46(2), respectively, configured to provide data security measures for data exchange between repositories 44(1) and 44(2) based on public/private key encryption.

As shown, each repository creates a key pair, which includes a public encryption key that the repository distributes to all other repositories, and a private key that it keeps private. The private key is uniquely paired with the public key. Thus, the first data encryption/decryption module 46(1) associated with the first repository 44(1) has a first public encryption key (Public Key 1) paired with a first private encryption key (Private Key 1). Similarly, the second data encryption/decryption module 46(2) associated with the second repository 44(2) has a second public encryption key (Public Key 2) paired with a second private encryption key (Private Key 2).

Referring to FIG. 9, when transmitting the traceability data, the transferring repository (the first repository 44(1)) starts by “signing” the data package by encrypting it with its private key (Private Key 1). After that, it then encrypts the signed package a second time, this time using the public key of the receiving repository (the second repository 44(2)), which is publicly available over the distributed network. Upon receipt, the receiving repository reverses the process. The “outer” layer of the traceability data package, which is encrypted using the receiving repository's public key (Public Key 2), can be decrypted the receiving repository's own private key (Private Key 2). More specifically, because of the pairing of the public and private keys, any data encrypted with the public key (Public Key 2) can only be decrypted with the corresponding private key (Private Key 2)—which only the receiving repository possesses. Thus, the paired key transfer reduces the risk of data being accessed by a third party if it is captured in transit. Upon decryption of the “outer” layer, the “inner” layer of the traceability data package, which is encrypted with the transferring repository's private key (Private Key 1) is decrypted by using the transferring repository's public key (Public Key 1), which is freely shared among all repositories across the distributed network. Again, the data, which is signed with the transferring repository's private key, can only be decrypted with its corresponding public key. Therefore, the receiving repository can be assured that the data has in fact originated from the repository-of-origin and has not been altered along the way.

In some embodiments, systems and methods of the present invention may utilize a blockchain repository for maintaining traceability data. A blockchain is a type of shared data repository that stores a sequence of transactions (a “block”) in a time-ordered sequence (a “chain”). The security methods used in a blockchain make it practically impossible to falsify or delete entries. The blockchain repository may be configured to maintain a continuously-growing list of data records that each refer to previous items on this list and is thus hardened against tampering and revision. The blockchain repository may be used to create an authenticated registry of traceability data.

The need for authentication in a traceability system is similar to that of a digital currency system. With digital currency, one method of fraud would be to use currency to make a payment to a first vendor and then reuse the same currency to make a payment to a second vendor. In the world of traceability, the parallel would be for a vendor to sell a lot of high-value traceable coffee to one buyer and then sell the same lot to another buyer, substituting low-value non-traceable coffee to one or both to make up the difference.

The blockchain respository may be configured to record assignments of products (e.g., the transfers of goods between members or entities in a supply chain), modeling them as transactions and registering them into the blockchain repository. This process may be analogous to a digital currency system recording transactions involving the transfer of digital currency from one party to another. The blockchain repository is used as an authentication repository. In particular, the systems and methods of the present invention may require high-performance access to data distributed through a peer-to-peer network and may also require decentralized authentication of that data. The blockchain respository may address at least the latter requirement (e.g, the decentralized authentication of data). Accordingly, the blockchain repository does not function as a real-time “working” repository for generating traceability reports or performing supply chain management functions, as it is not designed to provide high-performance access. Rather, the blockchain repository may be used for purposes of validation in non-real-time situations. For example, specific transfers can be confirmed through recourse to the blockchain for validation or dispute resolution.

As previously described, the interface 22 of the integrated supply chain system 12 is configured to present product information to a user 16 via the user's computing device based, at least in part, on data received by the system 12. In some embodiments, the system 12 is configured to output product information to a user in the form of a visual representation, such as an image or illustration, with which the user may interact via their GUI on their user device so as to view details regarding product information. For example, the system 12 may be configured to output product information to a user in the form of a visual rendering, such as a map, that includes traceability information in the form of geographic locations. As shown in FIG. 10, for example, a user may be presented with a map that includes various geographic locations (points A-D) associated with product movement and/or product handling/processing from a point of origin all the way through to the final exchange with a consumer. It should be noted that the map depicted in FIG. 10 is merely for purposes of illustration and the system of the present disclosure is configured to output other types of visual and interactive renderings for conveying product information. For example, the system 12 may be configured to generate and provide interactive timelines, reports, graphical representations, and the like.

The systems and methods described herein may be configured to aggregate information and generate a visual rendering of product information to provide to a given user in response to a request. For example, a user may access the system 12 and, in the event they are authorized, may request product information. In some instances, the request may be explicit in the sense that the user is logged into the system 12 and actively seeks the product information. Accordingly, the user may be provided with real-time visibility to traceability information of the product (e.g., current location, previous locations, upcoming locations or destinations).

The user may interact with the map so as to obtain specific details about a product. For example, the map of FIG. 10 depicts a visual representation of geographic locations (points A-D) associated with the movement of coffee from a point of origin at point A (e.g., farmer) all the way through to the final exchange of the coffee with a consumer at point D (e.g., sale of cup of coffee). In this instance, the user may be a consumer who has just purchased the cup of coffee and is interested in viewing information about that cup of coffee. However, it should be noted that the output of visual representation of product information, as described herein, may be provided to any one of the users associated with the supply chain, including, but not limited to, a manufacturer, producer, exporter, retailer, store owner, destination owner, etc. The user may interact with the map by simply selecting one of the points A-D so as to view product details associated with the geographic location selected.

The type of product information available at any given point (any of points A-D) may be based on the location associated with that point, the event or activity associated with that point, or other factors. As shown, a user may select point A, at which point the system 12 may further provide product information associated with that particular geographic location. Point A may generally correspond to the point of origin of the coffee (e.g., location in which the coffee was grown and harvested and possibly initially processed). Accordingly, the product information of point A may include, for example, the identity of the coffee product (e.g., name of coffee) and the characteristics of the coffee product (e.g., physical attributes of the coffee, including grading or classification, as well as the type of coffee product, which could be coffee cherry or parchment coffee, as point A is the point of origin). The product information may also include the identity of the location as well as characteristics of the location. In the instant example, the location may be a village or town in Ethiopia in which the coffee cherry was grown, harvested, and/or processed. The characteristics of the location may include the operator of the location, overall capacity of the location, current capacity of the location, seasonality of the location, operational status of the location, current weather at the location, and the like. The product information may further include details regarding an event or activity associated with point A. For example, the type of event may include the harvesting and subsequent sale of coffee cherry from the farmer to a producer or the processing of coffee cherry to produce parchment coffee. The details may include the date of harvest or processing, the total quantity harvested or processed, and the like. The product information may further include details about one or more members involved in the event, including details about the farmer and/or producer. The details may include a bio of the farmer or producer, harvest history of the farmer, processing history of the producer, and the like.

Upon selecting point D, the user may access product information associated with the sale of a cup of coffee to a consumer. Accordingly, some of the details of the coffee product have since been updated and additional details have been included at point D, as the product has moved through the supply chain and undergone multiple events/activities and exchanged hands multiple times. In this instance, the coffee product is no longer coffee cherry or coffee parchment, but rather a roasted coffee that has been brewed and served as an individual serving. Furthermore, the roasted coffee may include a blend of units of coffee product and may not be entirely composed of a single source of coffee bean, as previously described herein. For example, multiple units of parchment coffee may be blended during a milling process, thereby resulting in a blended green coffee (e.g., occurring at point B), and the blended green coffee may be further blended with other green coffee units during a roasting process. However, as previously described herein, the system 12 is configured to track individual units even when those individual units are split or combined with other individual units. Accordingly, the system 12 is able to provide a user with traceability information all the way back to the point of origin (point A).

Accordingly, the product information of point D may still include similar product information as was provided in point A (e.g., same identity of the coffee product, some of the similar characteristics of the coffee product, such as Arabica bean). However, the type of coffee product is now roasted coffee and the location of the coffee product has been updated to reflect the location of purchase (e.g., coffee shop in the United States). The characteristics of the location may include the operator of the location (e.g., name of the seller) and details about the seller. The product information may further include details regarding an event or activity associated with point D. For example, the type of event may include the sale of the cup of coffee from the seller to the consumer. The details may include the date of sale, the price paid for the cup of coffee, quantity of the cup of coffee, the type of the cup of coffee, and the like. The product information may further include details about one or more members involved in the event, including details about the seller and consumer. The details may include a bio of the seller, history of the seller producer, and the like.

It should be noted that at any point, a user may be able to navigate through the interface so as to pull up all types of product information associated with all events/activities occurring through the supply chain. For example, a user (in the event they have access) may be able to review the product information associated with point C (transportation of the product), which may include product transit logs, and the like. Similarly, a user may review product information associated with point B (production of the coffee product, such as milling of parchment coffee to create green coffee). Accordingly, in addition to providing real-time visibility of a product, the system 12 is configured to provide all types of traceability information associated with a product all the way through the supply chain from the final destination back through to the point of origin.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. A system associated with a first entity and configured to manage product traceability data of a product that is moving within a supply chain, the system comprising:
a first database comprising product traceability data associated with a product, the product traceability data comprising a unique identifier that is associated with the product; and
a hardware processor coupled to a memory containing instructions executable by the processor to cause the system to:
communicate with a second system associated with a second entity, the second system comprising a second database associated therewith;
receive an input that the product is being transferred to the second entity;
generate a copy of the product traceability data; and
transfer the copy of the product traceability data to the second database of the second system in order to provide the second entity with a traceable history of the product without the second database having to query the first database.

2. The system of claim 1, wherein each of the first and second databases are restricted-access databases.

3. The system of claim 1, wherein the first entity is separated from the second entity by one or more intermediate entities in the supply chain.

4. The system of claim 1, wherein the input that the product is being transferred comprises assignment data associated with an assignment of the product from the first entity to the second entity.

5. The system of claim 4, wherein the assignment data is selected from the group consisting of identity of the first and the second entities, type of assignment, consideration exchanged as part of the assignment, date and time of the assignment, and a combination thereof.

6. The system of claim 4, wherein the assignment comprises at least one of a transfer of ownership of the product and a transfer of custody of the product.

7. The system of claim 1, wherein the transfer of the copy of the product traceability data from the first database to the second database is peer-to-peer.

8. The system of claim 1, wherein the unique identifier is associated with a tag associated with the product.

9. The system of claim 8, wherein the tag comprises a digital representation of a machine-readable label or indicia.

10. The system of claim 9, wherein the machine-readable label of indicia is selected from the group consisting of text, graphics, an image, a linear barcode, a matrix barcode, an RFID element, and a combination thereof.

11. The system of claim 1, wherein the product comprises a product lot comprising one or more product units.

12. The system of claim 11, wherein each of the one or more product units has a tag associated therewith, wherein the product traceability data comprises a unique identifier associated with each tag.

13. The system of claim 1, wherein the product traceability data comprises product information selected from the group consisting of an identity of the product, characteristics of the product, a location of the product, characteristics of the location, traceability information of the product, transactional data related to one or more exchanges of the product, and a combination thereof.

14. The system of claim 13, wherein the characteristics of the product are selected from the group consisting of physical attributes of the product, origin of the product, destination of the product, and a combination thereof.

15. The system of claim 13, wherein the characteristics of the location of the product are selected from the group consisting of operator of the location, overall capacity of the location, current capacity of the location, seasonality of the location, operational status of the location, current weather at the location, and a combination thereof.

16. The system of claim 13, wherein the traceability information comprises supply chain activities or events associated with the product.

17. The system of claim 16, wherein the supply chain activities or events are selected from the group consisting of processing of the product, storage of the product, movement of product from one location to another location, sampling of the product, evaluation of the product, and a combination thereof.

18. The system of claim 13, wherein the transactional data is selected from the group consisting of identity of one or more entities associated with the exchange of the product, quantity of the product exchanged, price paid for the product, date of the exchange of the product, and a combination thereof.

19. The system of claim 1, wherein the copy of the product traceability data is transferred from the first database to the second database over a communication network.

20. A system for managing product traceability data of a product that is moving among entities in a supply chain, the system comprising a hardware processor coupled to a memory containing instructions executable by the processor to cause the system to:
communicate with a first database associated with a first entity and a second database associated with a second entity, the first database comprising product traceability data associated with a product, wherein the product traceability data comprises a unique identifier that is associated with the product;
receive an input that the product is being transferred to the second entity; and
send instructions to the first database to cause the first database to:
generate a copy of the product traceability data; and
transfer the copy of the product traceability data to the second database in order to provide the second entity with a traceable history of the product without the second database having to query the first database.
